(19) United States
(12) Patent Application Publication
(10) Pub. No.: US 2003/0142044 A1
(43) Pub. Date: Jul. 31, 2003

(54) License plate frame with programmable electronic display

(76) Inventor: James Berry, Mission Viejo, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/096,406

(22) Filed: Mar. 11, 2002

Related U.S. Application Data
(60) Provisional application No. 60/353,906, filed on Jan. 31, 2002.

(51) Int. Cl. G09G 3/20

(52) U.S. Cl. 345/55; 40/209

(57) ABSTRACT

A license plate frame for a motor vehicle is configured with a programmable display capable of displaying text messages, images, designs and/or animations. The display preferably includes a two-dimensional array of LEDs located along a portion, such as the bottom, of the license plate frame. The display is preferably driven by a display driver module and powered by a battery or a vehicle's electrical system. The driver module is preferably located within or behind the license plate frame. The display can be controlled through a remote control that can be located inside a vehicle. The remote control can be configured to communicate with the driver module through a physical wire connection or through a wireless connection. The display driver module can include a receptacle for a nonvolatile memory module, such as a chip or card, through which the driver module can be programmed or controlled.

### RELATED APPLICATIONS

This application claims the benefit of U.S. Provisional Application No. 60/353,906, filed on Jan. 31, 2002, which is hereby incorporated by reference.

### BACKGROUND OF THE INVENTION

1. Field of the Invention

The invention relates to license plate frames and, more particularly, the invention relates to a license plate frame configured with a programmable electronic display.

2. Description of the Related Art

License plate frames have been historically used to convey printed messages in the areas above and below a license plate on an automobile. Prior license plate frames, however, have not provided the ability to electronically control the displayed message.

### SUMMARY OF THE INVENTION

A license plate frame for a motor vehicle is configured with a programmable display capable of displaying text messages, images, designs and/or animations. The display preferably includes a two-dimensional array of LEDs located along a portion, such as the bottom, of the license plate frame. The display is preferably driven by a display driver module and powered by a battery or a vehicle's electrical system. The driver module is preferably located within or behind the license plate frame. The display can be controlled through a remote control that can be located inside a vehicle. The remote control can be configured to communicate with the driver module through a physical wire connection or through a wireless connection. The display driver module can include a receptacle for a nonvolatile memory module, such as a chip or card, through which the driver module can be programmed or controlled.

### BRIEF DESCRIPTION OF THE DRAWINGS

FIG. 1 illustrates a license plate frame with a programmable display in accordance with one embodiment of the invention.

FIG. 2 illustrates a system in which a programmable display of a license plate frame is controlled using a remote control.

### DETAILED DESCRIPTION OF THE INVENTION

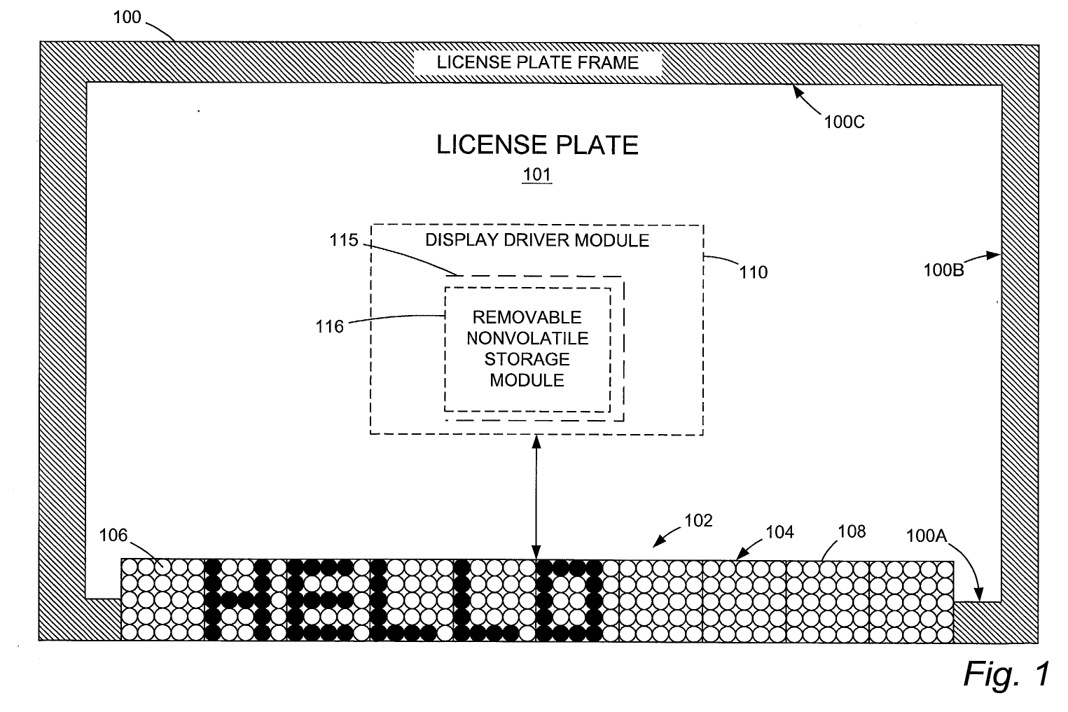

FIG. 1 illustrates a license plate frame 100 for a motor vehicle in accordance with one embodiment of the invention. The license plate frame 100 is configured with a programmable display 102 for conveying text messages, images, designs and/or animations. The display 102 is preferably an array 104 of LEDs 106 aligned along the bottom 1OOA of the license plate frame 100. The array 104 can alternatively be placed along either or both the sides 100B of the license plate frame, or at the top 100C of the license plate frame. The array can alternatively be configured to extend around a license plate 101 along part or all of the license plate frame 100.

In one embodiment, the array includes 8 sets of 5×7 red LED arrays 108 for a total array size of 5×56. As will be understood by one skilled in the art, other array sizes, such as 5×84 or 10×100 can be used, possibly using smaller LEDs 106 or LED arrays 108. In one embodiment, the LEDs 106 are configured to produce multiple colors of light, such as red, amber, and green. Alternatively, a liquid crystal display can be used. Other types of displays can also be used, as will be understood by one skilled in the art.

In one embodiment, a display driver module 110 is incorporated into a portion of the license plate frame 100 behind the display 102. Alternatively, the display driver module 110 can be positioned behind a top portion 112 of the frame or, in-part, behind both the display and the top portion 112 of the frame. The display driver module 110 can be configured to be located behind the license plate 101 in a separate backing plate (not illustrated) to which the frame and the license plate 101 are mounted.

In one embodiment, the display driver module 110 includes a receptacle 115 for a nonvolatile memory module 116, such as a chip or card, through which the driver module can be programmed or controlled. The nonvolatile memory module 116 can be a PROM or EPROM chip or a card such as a SmartMedia or CompactFlash card. Programs or instructions for displaying text messages, and optionally small images, can be stored on the memory module 116.

The formats for displaying text messages can include numerous possibilities such as flashing and/or scrolling. Other formats for displaying messages will be known to one skilled in the art. Images, animations or other variations of flashing lights can also be displayed. The memory module 116 can be connected to a home computer and program data can be stored on the memory module using known techniques.

In one embodiment, the display driver module 110 stores the image to be displayed in a set of shift registers to enable scrolling of text across the display 102. Alternatively, the display driver module 110 can include a microcontroller or integrated circuit configured for driving LED arrays.

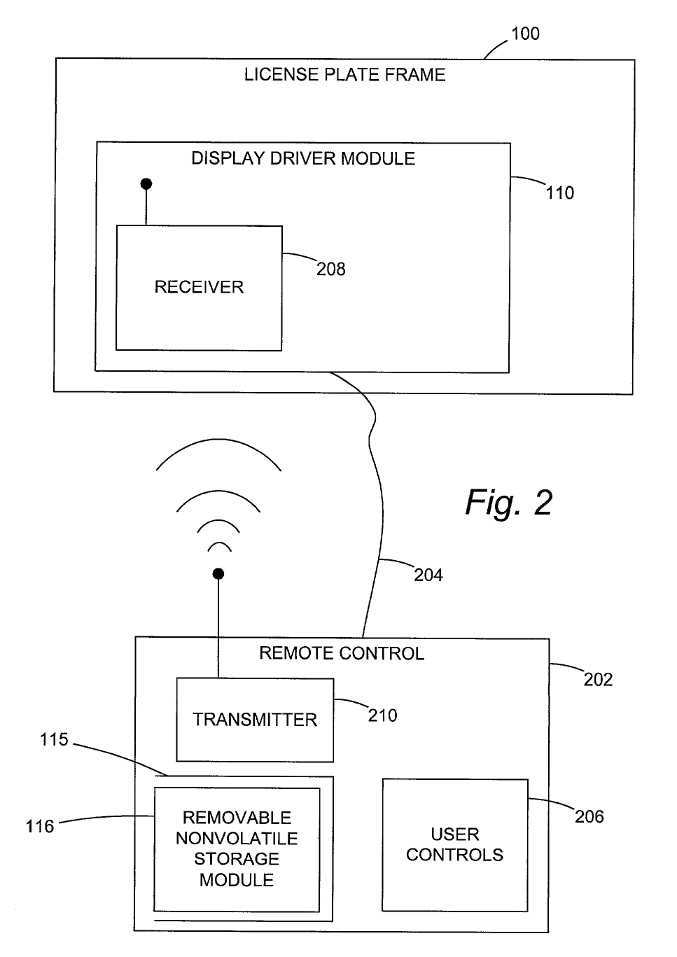

As illustrated in FIG. 2, in one embodiment, the display 102 is controlled through a remote control 202 that can be located inside the vehicle. In one embodiment, the remote control 202 is configured to communicate with the driver module 110 through a physical wire connection 204. In one embodiment, the driver module 110 is located in the remote control 202, with some minimal support circuitry sufficient to actuate the display 102 being located on the frame 100. The remote control 202 is preferably configured with user controls 206 through which the display 102 can be controlled. The user controls 206 can be used to program the programmable display 102 or to switch among previously stored or loaded programs. The receptacle 115 for the nonvolatile memory module 116 or an additional receptacle can be incorporated into the remote control 202.

In one embodiment, the user controls 206 include a single button (not illustrated). In this embodiment, operation of the button causes the display driver to cycle through each of a set of stored programs.

In one embodiment, the remote control 202 is plugged into the vehicle's cigarette lighter for power, for communication with the driver module 110 through the vehicle's electrical system, or for both power and communication with the driver module 110. Technology similar to available X10 technology can be used to support communication through the vehicle's electrical system from the remote control 202. In one embodiment, a battery, power supply or power connection is integrated into the remote control 202.

In one embodiment, the remote control 202 is configured to communicate with the driver module 110 through a wireless transmitter 208. In this embodiment, the driver module 110 is augmented with a wireless receiver 210.

In one embodiment, the remote control 202 is configured with an infrared receiver (not illustrated). In this embodiment, the remote control 202 is preferably mounted within the passenger compartment and operated or controlled through a small handheld remote control (not illustrated) having an infrared transmitter.

In one embodiment, the wireless receiver 210 can be configured to receive signals from systems and infrastructure that provide service to portable one-way text pagers, two-way text pagers or mobile telephones. In this manner, the display 102 can be operated or programmed from a remote location other than the passenger compartment. In one embodiment, a pager service can be used to send an alphanumeric message that is received by the wireless receiver 210 and displayed upon the display 102. Accordingly, in this embodiment the display 102 can be programmed from any telephone or e-mail service.

In one embodiment, the display 102 and the driver module 110 are powered by the vehicle's electrical system. In one embodiment, power is received through a connection to a vehicle's license plate light socket. Alternatively, power can be supplied from a battery located on, in, or adjacent to the license plate frame. In one embodiment, the battery is configured to be charged through the vehicle's electrical system.

In one embodiment, the display driver module 110 can be configured to receive an input signal from the brake lamp system of the vehicle. In this embodiment, the display can be configured to turn on some or all of the LEDs using a red color during vehicle braking.

In one embodiment, the license plate frame 100 is augmented with a deceleration detection module (not illustrated) configured to detect vehicle deceleration. The display driver module 110 is preferably configured to activate the display 102 based upon an input from the deceleration module to indicate braking or deceleration. In one embodiment, under severe deceleration, the display can be configured to blink or flash. The rate of blinking or flashing can be configured to increase with greater deceleration.

In one embodiment, the display driver module 110 can be configured to receive input signals from each of the left and right turn signal circuits of the vehicle. In this embodiment, the display 102 can be configured to display scrolling arrows or another indication of an intent to make a turn.

Although the invention has been described in terms of certain embodiments, other embodiments that will be apparent to those of ordinary skill in the art, including embodiments which do not provide all of the features and advantages set forth herein, are also within the scope of this invention. Accordingly, the scope of the invention is defined by the claims that follow.

What is claimed is:

1. A license plate frame comprising a two-dimensional array of controllable display elements, wherein the two-dimensional array is controlled by a display driver module.

2. The license plate frame of claim 1, further comprising the display driver module.

3. The license plate frame of claim 2, further comprising a receptacle for a removable nonvolatile data storage module.

4. The license plate frame of claim 1, further comprising a receiver configured to receive control signals transmitted by a remotely located transmitter.

5. A license plate frame comprising a plurality of controllable display elements arranged in a two-dimensional array.

6. The license plate frame of claim 5, wherein the elements are controlled by a display driver module.

7. A programmable license plate frame display system, the system comprising:
a license plate frame;
a display attached to the frame, the display comprising a plurality of controllable display elements arranged in a two-dimensional array; and
a display driver module configured to control the display.

8. The system of claim 7, wherein the display driver module is configured to display text messages on the display.

9. The system of claim 7, wherein the display driver module is configured to display images on the display.

10. The system of claim 7, wherein the display driver module is configured to display animated images on the display.

11. The system of claim 7, wherein the display driver module is attached to the frame.

12. The system of claim 7, further comprising a backing plate, wherein the frame is mounted to the backing plate and wherein the display driver module is attached to the backing plate.

13. The system of claim 7, further comprising a remote control.

14. The system of claim 13, wherein the remote control comprises user controls.

15. The system of claim 14, wherein the remote control comprises the display driver module.

16. The system of claim 7, further comprising a receptacle for a nonvolatile memory module.

17. The system of claim 17, wherein the driver module is configured to control the display based upon data stored on the nonvolatile memory module.

18. The system of claim 7, further comprising an input line configured to be connected to a vehicle brake lamp system, wherein the display is configured to be activated in response to an input signal received through the input line.

19. The system of claim 7, further comprising a receiver configured to receive control signals for controlling the display.

20. The system of claim 19, wherein the control signals are pager signals.
